(19) United States
(12) Patent Application Publication
(10) Pub. No.: US 2006/0221486 A1
(43) Pub. Date: Oct. 5, 2006

(54) Reading tracks from a media during back-EMF velocity control

(75) Inventor: Fernando A. Zayas, Loveland, CO (US)

Correspondence Address: FLIESLER MEYER, LLP, FOUR EMBARCADERO CENTER, SUITE 400, SAN FRANCISCO, CA, 94111, US

(73) Assignee: Matsushita Electric Industrial Co., Ltd., Kadoma-shi (JP)

(21) Appl. No.: 11/095,060

(22) Filed: Mar. 31, 2005

(51) Int. Cl. G11B 21/02; G11B 27/36; G11B 5/596

(52) U.S. Cl. 360/75; 360/31; 360/77.08

(57) ABSTRACT

A method in accordance with the present invention includes determining a set of tracks scanning during testing of the disk surface for defects. An average load position or a load position a slider over a disk surface from a ramp during loading and unloading from the disk surface is determined by performing repeated loading and unloading while determining a first de-modulated track. Once the average load position or load position range is determined, the information can be combined knowledge of the slider ABS geometry to assign a set of tracks for scanning.

### CROSS-REFERENCE TO RELATED PATENT APPLICATIONS

This U.S. Patent Application incorporates by reference all of the following co-pending applications:

U.S. patent application Ser. No. ______ entitled “Design for High Fly Write Immunity,” by Baldwinson, et al., filed concurrently (Docket No. PANA-01155US0).

U.S. patent application Ser. No. 10/349,798 entitled “Ramp Arrangement and Method for Measuring the Position of an Actuator in a Rotating Media Data Storage Device,” by Zayas et al., filed Jan. 22, 2003 (Docket No. PANAP-01055US0).

U.S. patent application Ser. No. 10/366,750 entitled “Ramp Arrangement and Method for Measuring the Position of an Actuator in a Rotating Media Data Storage Device,” by Zayas et al., filed Jan. 22, 2003 (Docket No. PANAP-01055US1).

U.S. patent application Ser. No. 10/733,131 entitled “Methods to Determine Gross and Fine Positioning on a Reference Surface of a Media,” by Richard M. Ehrlich et al., filed Dec. 10, 2003.

U.S. patent application Ser. No. 10/872,062 entitled “Method for Optimizing Dynamic Stroke in the Self Servo-Write Process,” by Calfee, et al., filed Jun. 18, 2004 (Docket No. PANAP-01128US0).

U.S. patent application Ser. No. 10/871,824 entitled “Dynamic Stroke Optimization in the Self Servo-Write Process,” by Calfee, et al., filed Jun. 18, 2004 (Docket No. PANAP-01128US1).

U.S. patent application Ser. No. 11/027,730 entitled “System and Method for Optimizing Track Spacing Across a Stroke,” by Gururangan, et al., filed Dec. 30, 2004 (Docket No. PANAP-01120US2).

### TECHNICAL FIELD

The present invention relates to methods to servowrite media for use in data storage devices, and systems for applying such methods.

### BACKGROUND

A hard disk drive typically contains one or more disks clamped to a rotatable spindle motor, at least one head mounted or integrally formed with a slider for reading data from and/or writing data to the surfaces of each disk, and an actuator utilizing linear or rotary motion for positioning the head(s) over selected data tracks on the disk(s). The actuator positions the read/write head over the surface of the disk as the spindle motor rotates and spins the disk.

As the slider is loaded onto a disk, for example from a ramp, an air bearing forms between the slider and the surface of the disk. Prior to the formation of a stabile air bearing, the slider may impinge on the surface of the disk causing material to be separated from one or both of the disk and the slider. It is desired that such damage be induced during the manufacturing process rather than during use and that such damage be detected so that the hard disk drive can be properly dispositioned. Further, it is desired that such a procedure for inducing and detecting such damage be as efficient as possible to improve manufacturing procedures.

### BRIEF DESCRIPTION OF THE FIGURES

Details of embodiments of the present invention are explained with the help of the attached drawings in which:

FIG. 1 is an exploded view of an exemplary hard disk drive for applying embodiments of the present invention;

FIG. 2A is a close-up view of a head suspension assembly used in the hard disk drive of FIG. 1, showing a head, a slider and a suspension;

FIG. 2B is a close-up view of the slider for use with the head suspension assembly of FIG. 2A;

FIG. 3 is a perspective view of the motion of the rotary actuator of FIG. 1 unloading the head from the disk;

FIG. 4 is a control schematic of a typical hard disk drive for applying a method in accordance with one embodiment of the present invention;

FIG. 5 is a diagram showing an example of a data and servo format for a disk in the drive of FIG. 1;

FIG. 6A illustrates a slider as the slider is loaded onto the disk;

FIG. 6B illustrates the slider of FIG. 6A lifting from the disk surface as the slider traverses debris;

FIG. 7 is a flowchart of an embodiment of a method in accordance with the present invention to calculate a data region for a plurality of disks;

FIG. 8 is a flowchart of an alternative embodiment of a method in accordance with the present invention to calculate a data region for a plurality of disks; and

FIG. 9 is a flowchart of a still further embodiment of a method in accordance with the present invention to calculate a data region for a plurality of disks.

### DETAILED DESCRIPTION

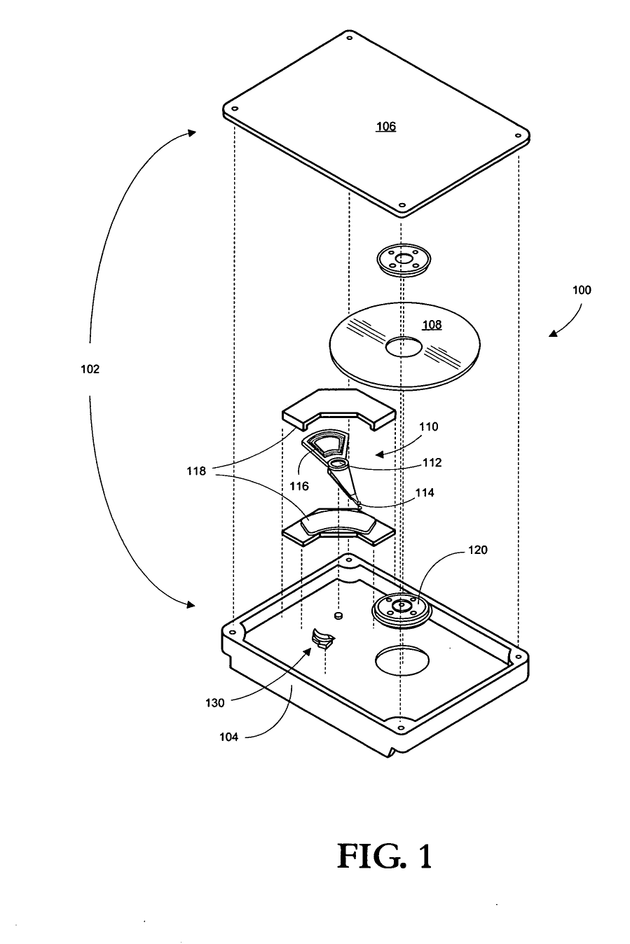

FIG. 1 is an exploded view of an exemplary hard disk drive 100 for applying a method in accordance with one embodiment of the present invention. The hard disk drive 100 includes a housing 102 comprising a housing base 104 and a housing cover 106. The housing base 104 illustrated is a base casting, but in other embodiments a housing base 104 can comprise separate components assembled prior to, or during assembly of the hard disk drive 100. A disk 108 is attached to a rotatable spindle motor 120, for example by clamping, and the spindle motor 120 is connected with the housing base 104. The disk 108 can be made of a light aluminum alloy, ceramic/glass or other suitable substrate, with magnetizable material deposited on one or both sides of the disk 108. The magnetic layer has tiny domains of magnetization for storing data transferred through heads 114. In one embodiment, each head 114 is a magnetic transducer adapted to read data from and write data to the disk 108. The disk 108 can be rotated at a constant or varying rate typically ranging from less than 3,600 to more than 15,000 RPM (speeds of 4,200 and 5,400 RPM are common in hard disk drives designed for mobile devices such as laptop computers). The invention described herein is equally applicable to technologies using other media, as for example, optical media. Further, the invention described herein is equally applicable to devices having any number of disks attached to the spindle motor 120. In other embodiments, the head 114 includes a separate read element and write element. For example, the separate read element can be a magneto-resistive head, also known as a MR head. It will be understood that multiple head 114 configurations can be used.

A rotary actuator 110 is pivotally mounted to the housing base 104 by a bearing 112 and sweeps an arc between an inner diameter (ID) of the disk 108 and a ramp 130 positioned near an outer diameter (OD) of the disk 108. Attached to the housing 104 are upper and lower magnet return plates 118 and at least one magnet that together form the stationary portion of a voice coil motor (VCM). A voice coil 116 is mounted to the rotary actuator 110 and positioned in an air gap of the VCM. The rotary actuator 110 pivots about the bearing 112 when current is passed through the voice coil 116 and pivots in an opposite direction when the current is reversed, allowing for precise positioning of the head 114 along the radius of the disk 108. Each side of a disk 108 can have an associated head 114, and the heads 114 are collectively coupled to the rotary actuator 110 such that the heads 114 pivot in unison. The invention described herein is equally applicable to devices wherein the individual heads separately move some small distance relative to the actuator. This technology is referred to as dual-stage actuation (DSA).

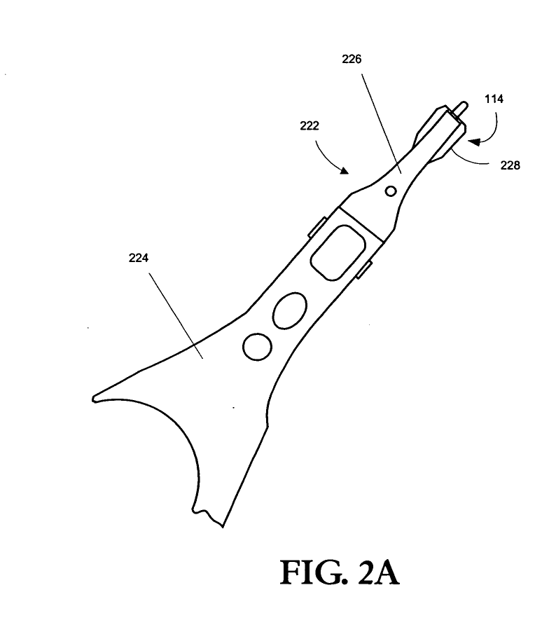

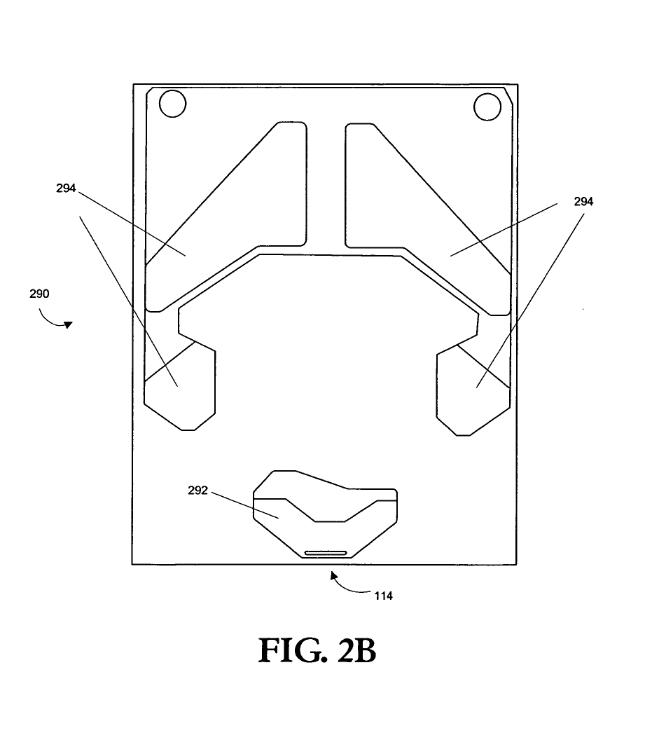

FIG. 2A details an example of a subassembly commonly referred to as a head suspension assembly (HSA) 222 comprising the head 114 formed on a slider 228, which is further connected with a flexible suspension member (a suspension) 226. The suspension 226 can be connected with an arm 224 which in one embodiment can be either integrally formed with a mount for a bearing 112 or separately attached to the mount. The head 114 can be formed on the slider 228 using a number of different techniques, for example the head 114 and slider 228 can be manufactured on a single die using semiconductor processing (e.g. photolithography and reactive ion etching). Spinning of the disk(s) 120 increases air pressure between the slider 228 and the surface of the disk, creating a thin air bearing that prevents the slider 228 (and consequently the head 114) from actually contacting the surface of the disk 108. A micro-gap of typically less than one micro-inch can be maintained between the disk 108 and the head 114 in one embodiment. The suspension 226 can be bent or shaped to act as a spring such that a force is applied to the disk 108 surface. The air bearing resists the spring force applied by the suspension 226, and the opposition of the spring force and the air bearing to one another allows the head 114 to trace the surface contour of the rotating disk 108—which is likely to have minute warpage—without “crashing” against the disk 108 surface. When a head 114 “crashes,” the head 114 collides with the disk 108 surface such that the head 114 and/or the disk 108 surface may be damaged.

FIG. 2B illustrates an exemplary air bearing surface (ABS) 290 of the slider 228 for use with the HSA 222 of FIG. 2A. The ABS 290 includes a trailing pad 292 on which the head 114 is connected, the trailing pad 292 being arranged near a trailing edge of the ABS 290. The head 114 includes a read element and a write element. The ABS 290 further includes three rails (also referred to herein as pads) 294 arranged near the periphery of the ABS 290. The rails 294 help produce the desired aerodynamics of the ABS 290 such that a desired fly height of the slider 228 is achieved. The ABS 290 shown in FIG. 2A is merely exemplary. ABSs 290 including rails 294 having myriad different geometric arrangements and heads 114 having myriad different arrangements relative to the rails 294 can be used in systems and methods of the present invention. Systems and methods in accordance with the present invention are not intended to be limited to diagrammatical representations of ABSs as presented herein.

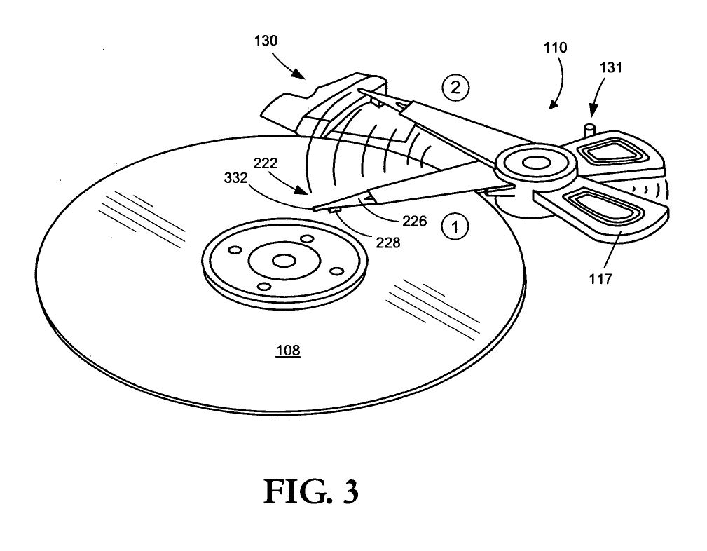

Refinements in disk fabrication have enabled manufacturers to produce disks 108 having ultra-smooth surfaces. Electrostatic forces can cause stiction between the slider 228 and the disk surface(s). If the speed of rotation of the disk 108 slows such that the air bearing collapses, the slider 228 can contact and stick to the surface of the disk 108, causing catastrophic failure of the hard disk drive 100. Stiction can cause the disk 108 to abruptly lock in position or stiction can cause the slider 228 to forcibly disconnect from the suspension 226. Thus, when the hard disk drive 100 is not in use and before rotation of the disks 108 is slowed and stopped (i.e., the disks 108 are “spun down”), the heads 114 can be removed from close proximity to the disk 108 surface by positioning the suspension 226 on a ramp 130 located either adjacent to the disk 108 or just over the disk 108 surface. FIG. 3 illustrates motion of the actuator 110 as the slider 228 is unloaded from the disk 108 and as the suspension 226 is driven up the ramp 130. The actuator 110 pivots from location 1, where the slider 228 is positioned over the disk 108 surface, to location 2, where the slider 228 is positioned adjacent to the disk 108. The range of motion of the actuator 110 is commonly referred to as a stroke. The stroke can be limited at an inner diameter by an ID crash stop 131. The ID crash stop 131 limits the free travel of the rotary actuator by acting as a physical block to a voice coil holder 117 of the actuator 110. As shown, the ID crash stop 131 is a peg or protrusion which can be associated with the housing. However, in other embodiments the ID crash stop 131 can be arranged in some other fashion, and/or can include some other device for limiting the rotation of the actuator 110. For example, in one embodiment, a tab can extend from the voice coil holder 117 or and can contact a peg or protrusion associated with the housing. One of ordinary skill in the art can appreciate the different ways in which the stroke of the actuator 110 can be blocked or limited. In some embodiments, an OD crash stop (not shown in the figure) may also be used. The OD crash stop can limit or block a pivoting movement of the actuator 110 at the OD.

The slider 228 is removed from close proximity with the disk 108 by pivoting the actuator 110 such that a lift tab 332 extending from the suspension 226 contacts the ramp surface and slides up the ramp 130. The position along the ramp 130 where the lift tab 332 first contacts the ramp 130 can be called the touch-point. As the lift tab 332 slides up the ramp 130 from the touch-point, the ramp 130 opposes the spring force of the suspension 226 and forces the slider 228 (and the head 114) away from the disk 108 surface. The HSA 222 can continue its motion along the stroke by traveling up the grade portion of the ramp 130 to a substantially flat portion that optionally can include a detent for cradling the lift tab 332. The slider 228 can be loaded back onto the disk 120 after the disk spins up to a safe speed. In other embodiments, the suspension 226 contacts the ramp 130 at a location along the suspension 226 between the slider 228 and the pivot point. Unloading the slider 228 from the disk 108 prevents sticking, and reduces a risk of damage from non-operating shock by suspending the slider 228 over a significantly wide gap between the slider 228 and an opposing slider or surface. In still other embodiments in accordance with the present invention, the hard disk drive 100 can include a ramp 130 positioned near the ID, rather than near the OD. In such embodiments, the slider 228 is removed from close proximity with the disk 108 by pivoting the actuator 110 toward the ID such that the lift tab 332 (or suspension 226) contacts the ramp surface and slides up the ramp 130. Methods in accordance with the present invention are equally applicable to such hard disk drives 100 having a ramp 130 positioned near the ID. Systems and methods described below are described with reference to embodiments of hard disk drives 100 having a ramp 130 positioned near the OD and an ID crash stop; however, it will be understood by one of ordinary skill in the art that such embodiments can alternatively include a hard disk drive 100 having a ramp 130 positioned near the ID and that such embodiments are within the scope of the present invention.

It should be noted, the description herein of the disk surface passing under or beneath the slider is intended to mean that portion of the disk surface that is in close proximity to the slider. It will be understood that when referred to as “beneath” or “under” the slider, the disk surface can be over, or adjacent to the slider in actual physical relation to the slider. Likewise, it will be understood that when referred to as “over” the disk surface, the slider can be beneath, or adjacent to the disk surface in physical relation to the disk surface. By extension, where the slider is beneath the disk surface, the suspension travels down the ramp when the slider is separated from the disk surface.

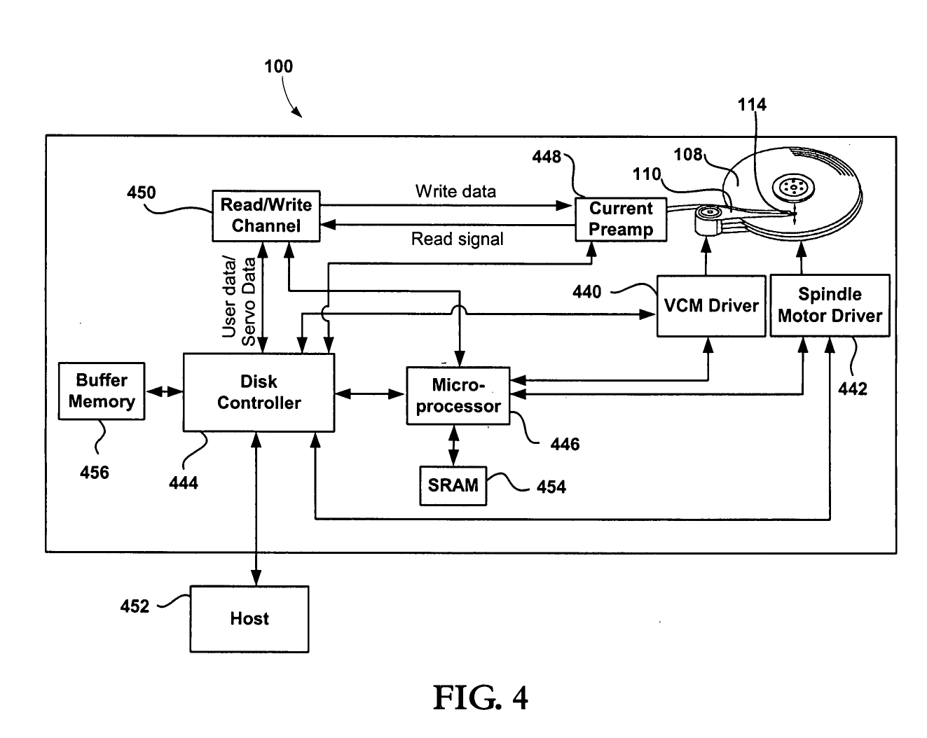

FIG. 4 is a control schematic for the exemplary hard disk drive 100 of FIG. 1. A servo system for positioning the head 114 can comprise a microprocessor 446 and a servo controller, the servo controller existing as circuitry within the hard disk drive 100 or as an algorithm resident in the microprocessor 446, or as a combination thereof. In other embodiments, an independent servo controller can be used. The servo system uses positioning data read by the head 114 from the disk 108 to determine the position of the head 114 over the disk 108. When the servo system receives a command to position a head 114 over a track, the servo system determines an appropriate current to drive through the voice coil 116 and commands a VCM driver 440 electrically connected with the voice coil 116 to drive the current. The servo system can further include a spindle motor driver 442 to drive current through the spindle motor 120 and rotate the disk(s) 108, and a disk controller 444 for sending information to and receiving information from a host 452 and for controlling multiple disk functions. The host 452 can be any device, apparatus, or system capable of utilizing the hard disk drive 100, such as a personal computer, Web server, or consumer electronics device. An interface controller can be included for communicating with the host 452, or the interface controller can be included in the disk controller 444. In other embodiments, the servo controller, VCM driver 440, and spindle motor driver 442 can be integrated into a single application specific integrated circuit (ASIC). One of ordinary skill in the art can appreciate the different means for controlling the spindle motor 120 and the VCM.

A flexible circuit (not shown) is connected with the rotary actuator 110 to supply current to the voice coil 116 and to provide electrical connections to the heads 114, allowing write signals to be provided to each head 114 and allowing electrical signals generated during reading to be delivered to pre-amplification circuitry (pre-amp) 448. Typically, the flexible circuit comprises a polyimide film carrying conductive circuit traces connected at a stationary end with the lower housing 104 and at a moving end to the rotary actuator 110. The disk controller 444 provides user data to a read/write channel 450, which sends signals to the pre-amp 448 to be written to the disk(s) 108. The disk controller 444 can also send servo signals to the microprocessor 446, or the disk controller 444 can control the VCM and spindle motor drivers directly. The disk controller 444 can include a memory controller for interfacing with buffer memory 456. In one embodiment, the buffer memory 456 can be dynamic random access memory (DRAM). The microprocessor 446 can include integrated memory or the microprocessor 446 can be electrically connected with external memory (for example, static random access memory (SRAM) 454 or alternatively DRAM).

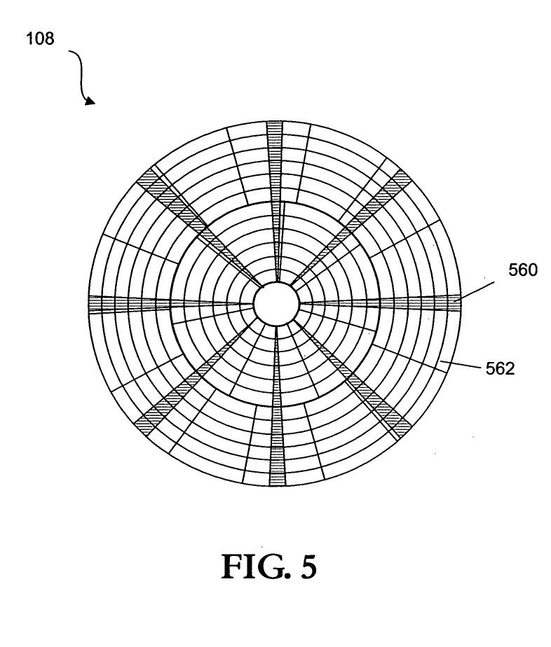

The information stored on such a disk can be written in concentric tracks, extending from near the ID to near the OD, as shown in the exemplary disk of FIG. 5. In an embedded servo-type system, servo information can be written in servo wedges 560, and can be recorded on tracks 562 that can also contain data. Data tracks written to the disk surface can be formatted in radial zones. Radial zones radiating outward from the ID can be written at progressively increased data frequencies to take advantage of an increase in linear velocity of the disk surface directly under a head in the respective radial zones. Increasing the data frequencies increases the data stored on the disk surface over a disk formatted at a fixed frequency limited at the ID by a circumference of a track at the ID. In a system where the actuator arm rotates about a pivot point such as a bearing, the servo wedges may not extend linearly from the ID to the OD, but may be curved slightly in order to adjust for the trajectory of the head as it sweeps across the disk.

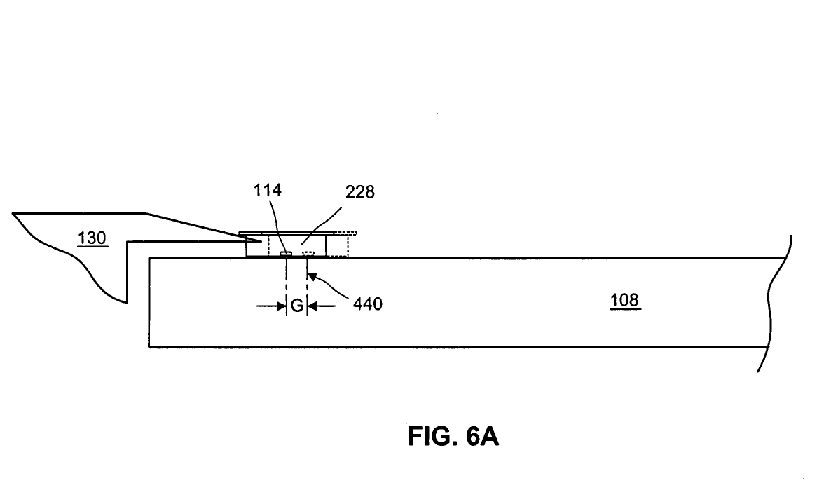

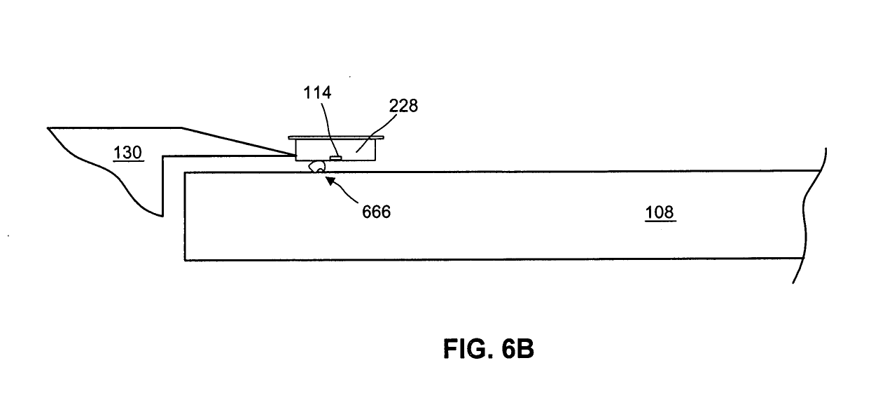

Referring to FIG. 6A, the slider 228 can be loaded onto the disk 108 from the ramp 130 when a read/write command is received and the disk rotates at sufficient speed to produce an air bearing between the disk and the slider. The HSA 222 is unstable when the slider is initially loaded due to suction forces and the transition from the graded ramp to the disk. Once the slider 228 stabilizes and an air bearing is established between the disk 108 and the slider 228, the head 114 can determine its position on the disk 108 by reading servo wedges passing beneath the head 114. After some criteria is met—e.g., the track can be read on a predefined number of consecutive servo wedges—the head 114 locks onto a track. The track on which the head 114 locks is called an acquire track. In one such technique for assigning an acquire track 440, ten consecutive acceptable servo wedges must be measured before a track number is recorded as an acquire track 440. The head 114 determines its position on the disk 108 surface by reading servo wedges (or timing bursts of template patterns) passing beneath the head 114. Servo wedges read by the head 114 identify servo tracks on the disk 108 surface. (Timing bursts of template patterns can also be used to identify tracks on the disk 108 surface, and methods in accordance with the present invention should not be construed as being limited in applicability to disk 108 surfaces having resolved servo wedges.)

A load track 440 can be used to determine an approximate load position of the slider 228 onto the disk 108. The load track can be the acquire track described above, a first track whose track number is successfully de-modulated after loading, or a track defined based on some other criteria. Variation between the maximum and minimum distance between the ramp 130 and the load track 440 (shown as a gap G) can be attributed to myriad factors, including sampling error, load velocity and track eccentricity. As the slider 228 is loaded onto the disk 108, the head 114 can enter the perimeter of the track just as a servo wedge is passing adjacent rather than directly beneath the head 114. The head 114 can continue to travel along the stroke toward the ID at a load velocity until the position of the head 114 can be sampled as the next servo wedge passes beneath the head 114. The sampling error and load velocity can result in a variation in the location of the load track 440 of several hundred tracks.

Referring to FIG. 6B, as the slider 228 is loaded onto the disk 108 from the ramp 130 (pivoting from location 2 to location 1 in FIG. 3), the slider 228 can contact the disk 108 surface, possibly damaging one or both of the disk 108 surface and the slider 228. Frequent loading of the slider 228 from the ramp 130 to the disk 108 can cause damage that can be exacerbated by the type of media used. Impinging of the slider 228 on the disk 108 can cause material to be separated from the disk 108, becoming debris 666 that can contaminate the disk 108 surface. Still further, the debris 666 can stick to the disk 108 surface so that as a rail 294 of the slider 228 traverses the debris 666, the slider 228 is lifted such that the head 114 is too far from the disk 108 surface to read and/or write from the disk 108. Such lifting can interfere with performance of the head 114.

A typical test procedure for determining whether performance of the head 114 is impacted by debris present on the disk 108 (which may have been generated by head loading operations) can include repeatedly loading and unloading the HSA 222 from the ramp 130 and subsequently scanning a region of the disk 108 with the head 114 to determine if undesirable surface conditions produce defects in reading and/or writing. Such a test procedure typically includes scanning a predefined region relative to an expected ramp position. For example, the region can range between servo tracks 2000 and 5000. It can be desired that the size of the region scanned be reduced to a range of tracks approximating a region of the respective disk surface subject to impact with rails 294 or the trailing pad 292 of the slider 228. By reducing the number of tracks scanned, the efficiency of the test procedure can be improved.

Embodiments of methods in accordance with the present invention can be applied to reduce a range of tracks scanned during testing by approximating a loading position of a slider 228 relative to a ramp 130. The loading position of the slider 228 can roughly be determined based on the geometry of the slider 228 (and the head 114 relative to the slider 228), a track number (e.g., the acquire track) identified by the head 114, and optionally the measured velocity of the slider 228 across the surface of the disk 108. The velocity of the slider 228 across the surface of the disk 108 can be calculated by measuring a back electromotive force (“Bemf”) of the VCM, for example, or by using some other technique (such as disclosed in U.S. paten application Ser. Nos. 10/349,798 and 10/366,750, incorporated herein by reference). By the time the head 114 reads a track number, a relatively stabile air bearing has been established between the slider 228 and the disk 108; therefore, the slider 228 may be loaded to the disk 108 some time before the track number is identified. (As described above, where the track measured is an acquire track, a criterion can include measuring ten consecutive servo wedges, for example.) To account for the variation in the lag time between track number identification and slider 228 loading, the load position of the slider 228 can be determined multiple times while load/unload of the slider 228 is performed on the HDD 100. A range of track numbers can be obtained over the course of loading and unloading, or a statistical average can be calculated from the multiple measurements for estimating the identified track. A travel distance of the slider 228 can be calculated based on the velocity of the slider 228 as estimated by the Bemf measurement and the track identification criteria.

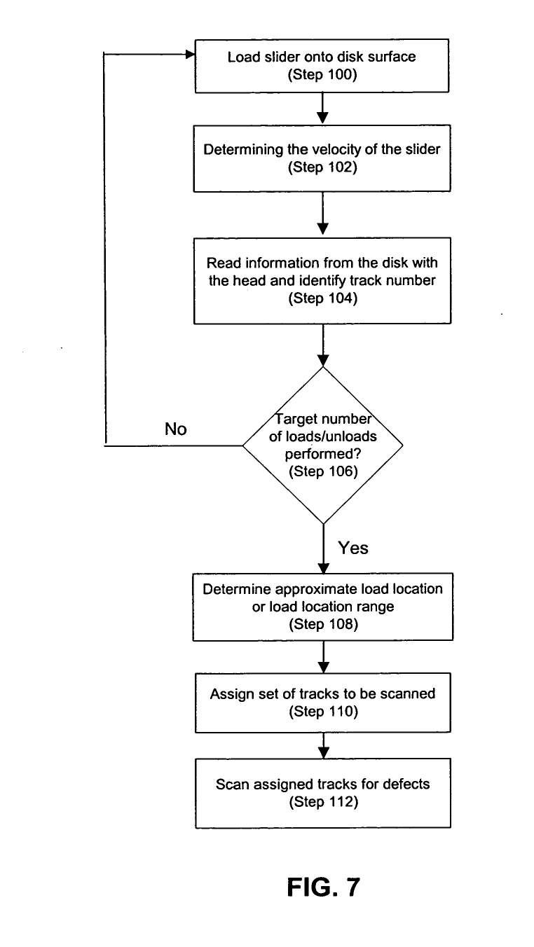

Referring to the flowchart of FIG. 7, an embodiment of a method in accordance with the present invention can include determining an approximate location over a disk 108 surface onto which a corresponding slider 228 is loaded. As described above, the slider 228 can be loaded onto the disk 108 surface (Step 100). As the slider 228 is loaded onto the disk 108, the velocity of slider 228 can optionally be determined to estimate travel distance (Step 102) from the load position of the slider 228 to the first measured track number. The head 114 reads and identifies a track number according to a scheme applied by the HDD 100 (Step 104). Once a given number of load/unloads are performed on the disk 108 (Step 106), an approximate load location or a range of load locations of the head 114 can be determined (Step 108). Referring again to FIG. 2B, a range of tracks assigned to be scanned includes a number of tracks spanning a width (D1-D2) traversed by the rails 294 of the slider 228 and/or the trailing pad 292 of the slider 228, the range of tracks being centered at the approximate load location or range of load locations of the head 114 (Step 110). Thus, in an embodiment the range of tracks assigned to be scanned can be the range of load locations of the head 114 plus the number of tracks spanning the position of the rail 294 and trailing pad 292 corresponding to the range of load locations of the head 114. The range of tracks assigned for scanning can then be scanned for defects caused by impinging of the slider 228 on the disk 108 surface (Step 112).

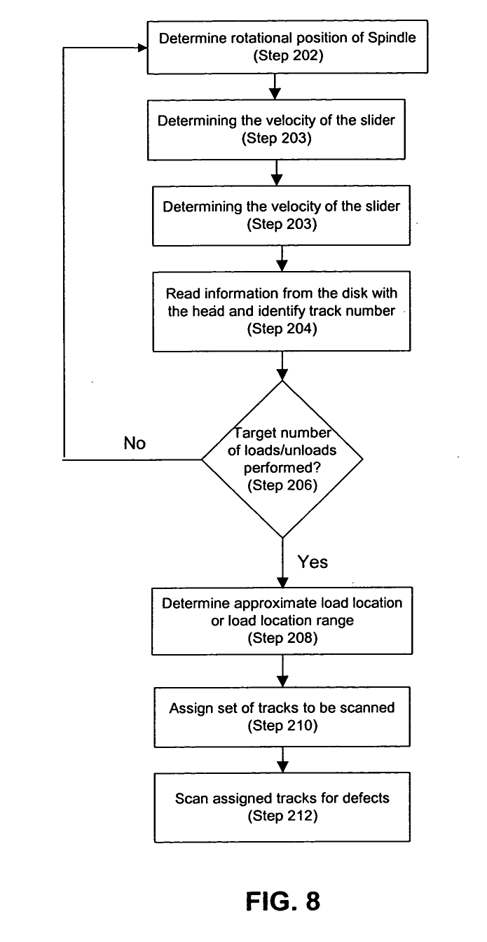

Referring to the flowchart of FIG. 8, an alternative embodiment of a method in accordance with the present invention can include determining the rotational position of the disk 108 by measuring the back electromotive force (Bemf) of the spindle (Step 200). In such an embodiment the slider 228 can be loaded onto the disk 108 within a range of servo wedges (as narrow a range as is achievable, for example) (Step 202). By increasing control over the loading location of the slider 228, scanning across a range of tracks can be performed over a range of servo wedges across the range of tracks, further reducing the total surface area scanned. Alternatively (or additionally), the range of tracks measured by the head 114 can be potentially reduced by improving the timing between the loading of the slider 228 onto the disk 108 and the passing of a servo wedge beneath the head 114. Alternatively, the slider 228 can be consistently loaded over a reduced range of servo wedges to increase the frequency of loadings within the range and increase the number of potential impacts between the slider 228 and the disk 108 surface within the reduced range of servo wedges. Thus, the test procedure is controlled so that the disk 108 surface is more rigorously tested (i.e., beaten up). Further, due to an increase in loadings within the range of servo wedges, a total number of loadings of the slider 228 onto the disk can be reduced (if desired), thereby reducing test time. As above, as the slider 228 is loaded onto the disk 108, the velocity of slider 228 can optionally be determined to estimate travel distance (Step 203) from the load position of the slider 228 to the first measured track number. The head 114 reads and identifies a track number according to a scheme applied by the HDD 100 (Step 204). Once a given number of load/unloads are performed on the disk 108 (Step 206), an approximate load location or a range of load locations of the head 114 can be determined (Step 208), the range of tracks being centered at the approximate load location or range of load locations of the head 114 (Step 210). Thus, in an embodiment the range of tracks assigned to be scanned can be the range of load locations of the head 114 plus the number of tracks spanning the position of the rail 294 and trailing pad 292 corresponding to the range of load locations of the head 114. The range of tracks assigned for scanning can then be scanned for defects caused by impinging of the slider 228 on the disk 108 surface (Step 212).

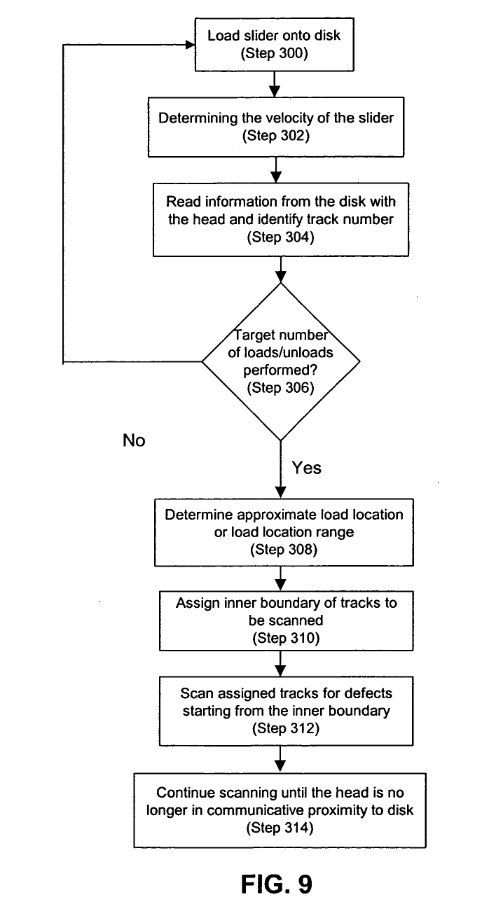

Referring to FIG. 9, a still further embodiment of a method in accordance with the present invention can include can include determining an approximate location over a disk 108 surface onto which a corresponding slider 228 is loaded and assigning an inner boundary for scanning based on the approximate location. As described above, the slider 228 can be loaded onto the disk 108 surface (Step 300). As the slider 228 is loaded onto the disk 108, the velocity of slider can optionally be determined to estimate travel distance (Step 302) from the load position of the slider 228 to the first measured track number. The head 114 reads and identifies a track number according to a scheme applied by the HDD 100 (Step 304). Once a given number of load/unloads are performed on the disk 108 (Step 306), an approximate load location or a range of load locations of the head 114 can be determined (Step 308), an inner boundary for a scanning region can be estimated for the range of tracks being centered at the approximate load location or range of load locations of the head 114 (Step 310). Thus, in an embodiment the inner boundary for a scanning region can be the average load location of the head 114 (or alternatively some other reference, such as a maximum measured deviation of the load position of the head 114) plus the number of tracks spanning the position of the corresponding rail 294 and trailing pad 292. Tracks can then be scanned starting from the inner boundary of the scanning region for defects caused by impinging of the slider 228 on the disk 108 surface (Step 312). In such an embodiment, the head 114 can optionally continue to scan the disk surface until the slider 228 is pulled off of the disk 108 by movement of the HSA 222 along the ramp 130, causing the head 114 to no longer be in communicative proximity with the disk 108 surface (Step 314). As long as the touch point is of the HSA 222 and the ramp 130 is approached sufficiently slow, it is possible to test the disk 108 surface even though the lift tab 332 (or suspension) is in contact with the ramp 130. This can be especially true in a self-servo written environment where the tracks are nearly perfectly round and there is no eccentricity relative to the ramp 130.

A number of scans performed, the range of scanned tracks, or the number of load/unload operations performed can vary, one or more of the variables being increased when an indication of damage is noted. Such an indication can include an observation during the ramp load/unload procedure that the acquire track has moved further toward the ID, for example, or that a ramp 130 load time (i.e., the time from the start of a ramp load after resistance calibration to acquire a signal from the disk 108) increases.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. The embodiments were chosen and described in order to best explain the principles of the invention and its practical application, thereby enabling others skilled in the art to understand the invention for various embodiments and with various modifications that are suited to the particular use contemplated. Aspects of the embodiments can be combined with aspects of many of the other embodiments, but an exhaustive combination of all such variations is not presented herein. It is intended that the scope of the invention be defined by the claims and their equivalence.

1. A method of testing a disk surface in a hard disk drive having a rotary actuator, a slider operably connected with the rotary actuator, a head associated with the slider, and a ramp to remove the slider from communicative proximity with the disk surface, the method comprising:
loading the slider onto the disk surface;
reading information on the disk surface with the head;
identifying a track number based on said information;
determining an approximate load position based on said track number;
assigning a set of tracks to scanned based on the approximate load position; and
scanning said set of tracks with the head.

2. The method of claim 1, further comprising:
determining a velocity of the slider;
wherein said approximate load position is determined based on said track number and said velocity of the slider.

3. The method of claim 2, further comprising:
measuring a back electromotive force of the rotary actuator; and
determining the velocity of the slider based on the back electromotive force of the rotary actuator.

4. The method of claim 1, further comprising:
determining a rotational position of the disk; and
wherein loading the slider onto the disk surface is based on the rotational position of the disk.

5. The method of claim 4, further comprising:
measuring a back electromotive force of the spindle; and
wherein the rotational position of the disk is determined based on the back electromotive force of the spindle.

6. A method of testing a disk surface in a hard disk drive having a rotary actuator, a slider operably connected with the rotary actuator, a head associated with the slider, and a ramp to remove the slider from communicative proximity with the disk surface, the method comprising:
loading the slider onto the disk surface;
reading information on the disk surface with the head;
identifying a track number based on said information;
determining an approximate load position based on said track number;
assigning an inner boundary to begin scanning a plurality of tracks based on the approximate load position; and
scanning the plurality of tracks with the head starting from the inner boundary and moving toward the ramp.

7. The method of claim 6, further comprising:
determining a velocity of the slider;
wherein said approximate load position is determined based on said track number and said velocity of the slider.

8. The method of claim 7, further comprising:
measuring a back electromotive force of the rotary actuator; and
determining the velocity of the slider based on the back electromotive force of the rotary acutator.

9. The method of claim 6, further comprising:
determining a rotational position of the disk; and
wherein loading the slider onto the disk surface is based on the rotational position of the disk.

10. The method of claim 9, further comprising:
measuring a back electromotive force of the spindle; and
wherein the rotational position of the disk is determined based on the back electromotive force of the spindle.

11. A method of testing a disk surface in a hard disk drive having a rotary actuator, a slider operably connected with the rotary actuator, a head associated with the slider, and a ramp to remove the slider from communicative proximity with the disk surface, the method comprising:
performing a plurality of load/unload sequences, a load/unload sequence including:
loading the slider onto the disk surface;
reading information on the disk surface with the head;
identifying a track number based on said information;
determining an approximate load position based on said plurality of load/unload sequences;
assigning an inner boundary to begin scanning a plurality of tracks based on the approximate load position; and
scanning the plurality of tracks with the head starting from the inner boundary and moving toward the ramp.

12. The method of claim 11, further comprising:
determining a set of tracks based on the approximate load position, wherein the set of tracks is disposed between the ramp and the inner boundary; and
scanning the set of tracks with the head.

13. The method of claim 11, wherein a load/unload sequence further includes determining a velocity of the slider.

14. The method of claim 13, wherein determining a velocity of the slider includes measuring a back electromotive force of the rotary actuator.

15. The method of claim 11, further comprising:
determining a rotational position of the disk; and
wherein loading the slider onto the disk surface is based on the rotational position of the disk.

16. The method of claim 15, further comprising:
measuring a back electromotive force of the spindle; and
wherein the rotational position of the disk is determined based on the back electromotive force of the spindle.
